(19) United States
(12) Patent Application Publication
(10) Pub. No.: US 2010/0185612 A1
(43) Pub. Date: Jul. 22, 2010

(54) Method for Producing an Ordered Search List

(75) Inventors: Matthew Kelly, San Jose, CA (US); Tom Becker, San Jose, CA (US); Joselito Surdilla, Union City, CA (US); Chris Kincanon, San Jose, CA (US)

Correspondence Address: Stevens Law Group, 1754 Technology Drive, Suite #226, San Jose, CA, 95110, US

(73) Assignee: Hotchalk Inc., Campbell, CA (US)

(21) Appl. No.: 12/353,123

(22) Filed: Jan. 13, 2009

(51) Int. Cl. G06F 17/30; H04L 9/32; G06F 7/04

(52) U.S. Cl. 707/732; 726/5; 707/E17.109; 707/E17.108

(57) ABSTRACT

The invention is directed to a method for producing, for example, a search results listing for educational content, where the listing is ordered based not only on content relevance to the search request, but also on the subscription status and entity affiliation of the user as related to the content. This places, near the top of the list, results that may be not only more relevant to the user, but those that may also be more efficiently accessed. For example, a method for an education-related content search, configured according to the invention, receives a login input from a user and extracts user data corresponding to the login input. Upon receiving a search request, the user data and the search request is transmitted, and an ordered search list that is ordered based on the user data is received.

### BACKGROUND OF THE INVENTION

In the field of education, the Internet is becoming an integral part of the curriculum preparation process. Educators often search for reference materials online and integrate them into their lesson plans. These reference materials may be offered by various providers, and many of the more coveted materials may be accessed only via paid subscription. Thus, a search request may be submitted and a list of results displayed to the user, who may select one of the results for further review. Upon selection, the content corresponding to the result may turn out to be on point; however, the user may not have the required subscription necessary for access to view the full content of the record. Often, the user is offered the option to purchase a subscription, but more often than not, the user will first proceed to examine other listed results in search of similarly relevant content for which no subscription is required, or to which the user has already subscribed. This procedure may be time-consuming, disorganized, and often irritating for the user.

In addition, an educator may be affiliated with an entity, such as a school, district, or state, that has produced or made available its own reference materials. These materials may be particularly relevant to the educator's needs, or they may be intended to be used by many or all educators belonging to that entity for purposes of consistency. Thus, should these materials be included in the search among the non-entity materials, whether freely available or subscription-based, it would be beneficial for the educator to see these entity-specific materials listed in a noticeable manner, such as relatively near the top of the results list. However, current search methods for reference materials yield results based on keyword or content-specific relevance, and lack methods for weighting the results based on the user's affiliation with an educational entity or subscription privileges.

Hence, it is desirable to have a solution without the above-described disadvantages. As will be seen, the invention provides such a solution in an elegant manner.

### BRIEF DESCRIPTION OF THE DRAWINGS

FIG. 1 illustrates an embodiment of the invention.

FIG. 2 illustrates another embodiment of the invention.

FIG. 3 illustrates another embodiment of the invention.

FIGS. 4A-B illustrate another embodiment of the invention.

### DETAILED DESCRIPTION OF THE INVENTION

The invention is directed to a method for producing, for example, a search results listing for educational content, where the listing is ordered based not only on content relevance to the search request, but also on the subscription status and entity affiliation of the user as related to the content. This places, near the top of the list, results that may be not only more relevant to the user, but those that may also be more efficiently accessed.

For example, a method for an education-related content search, configured according to the invention, receives a login input from a user and extracts user data corresponding to the login input. Upon receiving a search request, the user data and the search request is transmitted, and an ordered search list that is ordered based on the user data is received.

Another method for searching a set of education-related content, configured according to the invention, receives a login input from a user and extracts user data corresponding to the login input. Upon receiving a search request, the user data and the search request are transmitted. An ordered search list is then received, the ordered search list including a plurality of found records, wherein the plurality of found records are a subset of the set of education-related content, and wherein the plurality of found records are ordered based on a weighting system employing the user data.

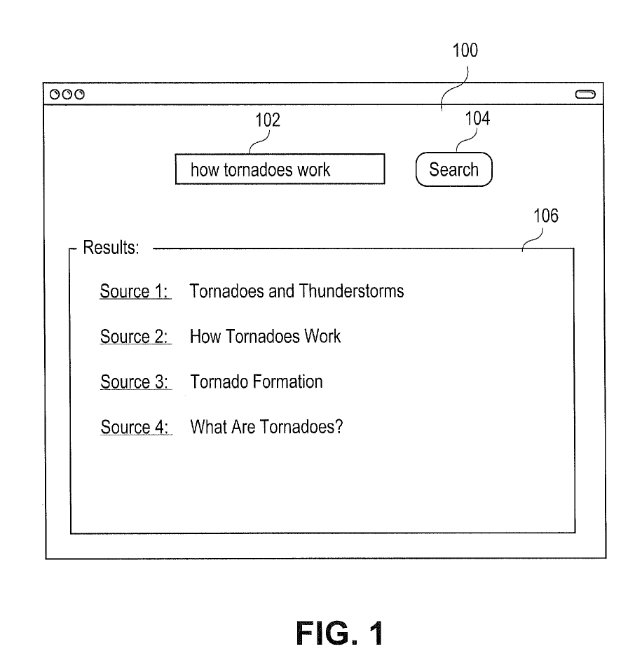

An example of a search results listing is shown in FIG. 1. In window 100, a user has entered “how tornadoes work” in search text box 102, and pressed the search button 104 to initiate the search process. In response, a list of results 106 has been displayed. The results list includes four sources seen in this figure, but an actual results list may include hundreds or even thousands of results. In an embodiment of the invention, results that may be more relevant to the user are listed closer to the top. For example, assuming that all four sources are equally relevant based on content, Source 1 may include reference material developed by the user's school, Source 2 may include material to which the user is subscribed, Source 3 may include free material accessible without subscription, and Source 4 may indicate subscription-required material to which the user is not subscribed. This aids the user by providing an order in which the user may click on results starting at the top of the list, so as to encounter materials that are more efficiently accessible and/or relevant with regard to the user's particular educational context.

The invention is not, however, limited to the above example, and various weighting schemes with different factors, such as subscription status and affiliated entity information, carrying different weights, may be employed.

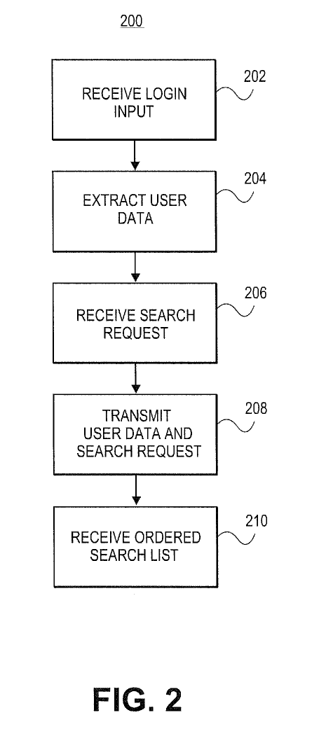

An embodiment of the invention is shown in flowchart 200 of FIG. 2. For example, in a method for an education-related content search, a login input may be received from, for example, a user at 202. The login input may include, but is not limited to, a username and password. User data corresponding to the login input is then extracted at step 204. This user data may include, but is not limited to, the user's content subscription information and affiliated entity information, such as but not limited to a school, district, or state. The subscription information may include a package identifier that indicates a content package to which the user is subscribed. For example, a user may be subscribed to a subject-based or grade-based video package from a content provider such as but not limited to NBC News or National Geographic.

The extracted user data may optionally be stored for later use. Upon receiving a search request at 206 from a user, the user data and the search request may be transmitted at 208 to, for example, a search index. The search request may include, but is not limited to, subject keywords, title, author, dates of relevance, and other search criteria.

An ordered search list is received in response at 210, where the list includes results ordered based on the user data. For example, the search index may perform a search based on the search request, and order the results of the search based on the user data and/or based on the content relevance, or relevance of the results to the contents of the search request. Hence, in the example of FIG. 1, Sources 1-4 may be ordered as such based on the relevance of each source to the user's search terms “how tornadoes work,” as well as on, for example, the subscription status or entity affiliation of the user as related to each source. The search index may first produce a preliminary list, and then rearrange the list based on the user data, and/or content relevance.

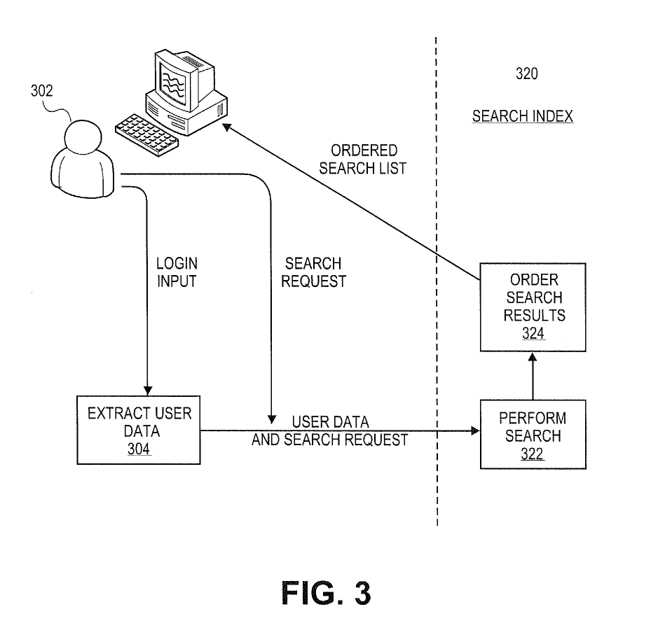

FIG. 3 illustrates an example of an embodiment of the invention as used to provide a user 302 with an ordered search list. Once the user's login input is received, user data is extracted at 304. Along with the user's search request, the user data is sent to search index 320. The search index 320 performs the search at 322 and orders the search results at 324. The ordered search list is then sent back from the search index 320, and may then be displayed for the user.

In an embodiment of the invention, the ordering of the list may be based on a weighting system employing the user data. The weighting system may employ a “boosting” system, where one factor may be assigned a boost and a second factor may be assigned another boost. The two factors may receive different levels of boosting, based on the nature of the factor. A factor may be an account item within the set of user data, such as but not limited to subscription information or an entity affiliation such as a school, district, state, or other organization. A user's account item may be taken into consideration in conjunction with the nature of the source itself, for example, whether the source requires a subscription for access, and whether the source is developed or provided by a particular school or district. Another factor may be the relevance of the result to the user's search criteria.

As an example, depending on what may be preferred by the relevant user community, a source containing material developed by a school district may be given either more or less weight than a source, with the same content relevance, to which the user is subscribed. If given more weight, the district material may be listed higher than the subscription material in the list, and vice-versa.

Further, an embodiment of the invention may also allow a first source of less content relevance to potentially be listed higher in the results list than a second source of more content relevance, if the first source is weighted higher with regard to user data, i.e., subscription status or entity affiliation. In order for the first source to be listed higher than the second source, it may be required that the difference, between the respective weights based on user data, be above a particular threshold. Alternatively, the invention may be configured so that content with more relevance is always listed higher, without regard to the user data. Again, various weighting schemes, not covered by the particular examples above, may be used as will be known to one of ordinary skill in the art.

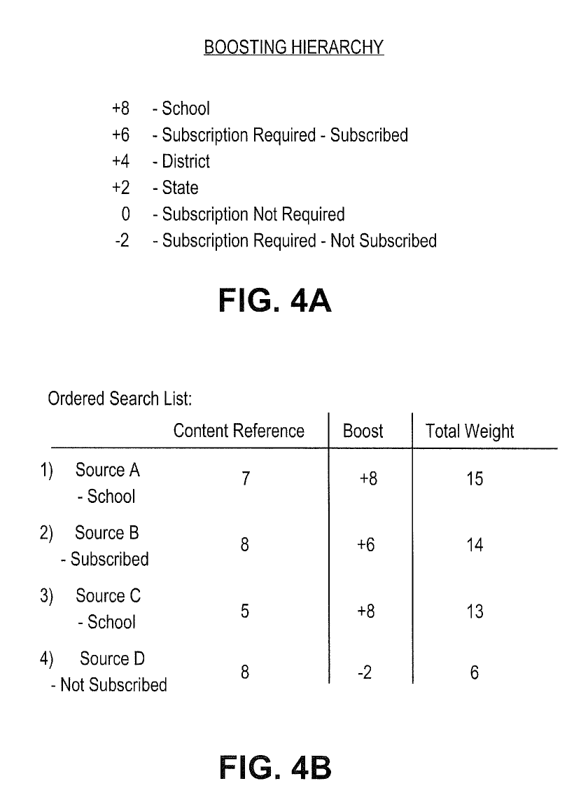

Given the sample boosting hierarchy of FIG. 4A, a sample weighting scheme is shown in FIG. 4B. In this example, content relevance is considered in conjunction with the user data. For example, although Source B may be slightly more relevant with regard to the user's search criteria than Source A, Source A is listed above Source B because Source A contains material provided by the user's school. The weighting scheme may be configured in this manner if, for example, the school or district has determined that use of a school's own material should be preferred over subscription material. Should the school or district prefer otherwise, the weighting scheme could be alternatively configured accordingly.

With regard to Source C, although it contains school material, its content relevance is significantly below that of Source B. Thus, it will be listed below Source B. Source D has a determined content relevance equal to that of Source B, but is listed below both Sources B and C because the user is not subscribed to it, and thus may not access it. However, the user may choose to select the result, and may, for example, be offered an option to purchase access to the content.

The particular numerical figures in FIGS. 4A-B are used only to illustrate the inventive concepts, and the invention is in no way bound to the use of these numbers. The formula for determining the order of search results is also not bound to a mere addition of two numbers, and may include any of various appropriate algorithms. Further, the use of numbers is not necessary for the implementation of the invention, and the weighting system may be implemented by any of various methods known to one of ordinary skill in the art.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

The methods include a novel approach to weighting ordered search lists so as to provide ease of use and efficiency for the user. Although the above embodiments are described and illustrated in the context of educational material, the scope of the invention extends to other applications where such functions are useful. Furthermore, while the foregoing description has been with reference to particular embodiments of the invention, it will be appreciated that these are only illustrative of the invention and that changes may be made to those embodiments without departing from the principles of the invention, the scope of which is defined by the appended claims and their equivalents.

What is claimed is:

1. A method for an education-related content search, comprising:
receiving a login input from a user;
extracting user data corresponding to the login input;
receiving a search request;
transmitting the user data and the search request; and
receiving an ordered search list that is ordered based on the user data.

2. The method of claim 1, wherein the login input includes one of a username and password.

3. The method of claim 1, wherein the user data is related to one of a school, district, state, and subscription information.

4. The method of claim 3, wherein the subscription information includes a package identifier.

5. The method of claim 4, wherein the package identifier indicates content to which the user is subscribed.

6. The method of claim 1, wherein the ordered search list is further ordered based on content relevance.

7. The method of claim 1, wherein the user data and the search request are transmitted to a search index.

8. The method of claim 7, wherein the ordered search list is received from the search index.

9. The method of claim 7, wherein the search index performs a search based on the search request to produce a preliminary list including one or more preliminary results, and arranges the one or more preliminary results in an order based on the user data to produce the ordered search list.

10. The method of claim 9, wherein the search index further arranges, based on content relevance, the one or more preliminary results within the preliminary list.

11. The method of claim 9, wherein the user data includes a first account item and a second account item on which the order is based, such that the first account item is weighed differently than the second account item in determining the order.

12. The method of claim 11, wherein one of the first account item and the second account item is related to one of a school, district, state, and subscription information.

13. A method for searching a set of education-related content, comprising:
receiving a login input from a user;
extracting user data corresponding to the login input;
receiving a search request;
transmitting the user data and the search request; and
receiving an ordered search list including a plurality of found records, wherein the plurality of found records are a subset of the set of education-related content, and wherein the plurality of found records are ordered based on a weighting system employing the user data.
